(19) United States
(12) Patent Application Publication
(10) Pub. No.: US 2026/0116480 A1
(43) Pub. Date: Apr. 30, 2026

(54) SPARE TIRE ANTI-THEFT DEVICE, AND VEHICLE INCLUDING SAME

(71) Applicant: NISSAN NORTH AMERICA, INC., Franklin, TN (US)

(72) Inventors: Roberto Carlos FLORES MARMOLEJO, Aguascalientes (MX); Jose Francisco SILVA ZAVALZA, Aguascalientes (MX)

(21) Appl. No.: 18/934,155

(22) Filed: Oct. 31, 2024

(51) Int. Cl. B62D 43/00; B62D 43/04

(52) U.S. Cl. CPC B62D 43/007; B62D 43/045

(57) ABSTRACT

A spare tire anti-theft device for a vehicle is disclosed herein. In an embodiment, device includes a latch, a lever and a mechanical line. The latch is configured to move between a locked configuration that prevents a tire hoist from releasing a spare tire from a tire storage space and an unlocked configuration that allows the tire hoist to release the spare tire from the tire storage space. The lever is operable between a first position and a second position. The mechanical line includes a first end operatively connected to the latch and a second end operatively connected to the lever. The mechanical line causes the latch to move from the locked configuration to the unlocked configuration when the lever is moved from the first position to the second position so that the tire hoist can release the spare tire from the tire storage space.

### BACKGROUND

### Field of the Disclosure

The present disclosure generally relates to an anti-theft device for a vehicle's spare tire. More specifically, the present disclosure relates to a tamperproof anti-theft device that locks and unlocks a tire hoist coupled to the spare tire.

### Background Information

Most vehicles are equipped with a spare tire for emergencies. In some cases, the spare tire is stored on an underside of the vehicle. For example, trucks typically store a spare tire under the rear flatbed. SUVs and other large vehicles can store a spare tire in similar locations. In many cases, the spare tire is stored using a tire hoist that raises and lowers the spare tire as needed.

### SUMMARY

Existing tire hoists are susceptible to tampering and theft of the spare tire secured thereto. The present disclosure provides an anti-theft device attached to or combined with a tire hoist to lock a spare tire into a storage space and prevent tampering.

In view of the state of the known technology, one aspect of the present disclosure is to provide a spare tire anti-theft device for a vehicle. The device includes a latch, a lever and a mechanical line. The latch is configured to move between a locked configuration that prevents a tire hoist from releasing the spare tire from a tire storage space and an unlocked configuration that allows the tire hoist to release the spare tire from the tire storage space. The lever is operable between a first position and a second position. The mechanical line includes a first end operatively connected to the latch and a second end operatively connected to the lever. The mechanical line causes the latch to move from the locked configuration to the unlocked configuration when the lever is moved from the first position to the second position so that the tire hoist can release the spare tire from the tire storage space.

Another aspect of the present disclosure is to provide a spare tire anti-theft storage system for a vehicle. The system includes a winch drum, a ratchet gear, a pawl and a release mechanism. The winch drum is configured to wind a spare tire into a tire storage space and release the spare tire from the tire storage space. The ratchet gear is operatively connected to the winch drum and configured to rotate in a first direction when the winch drum winds the spare tire into the tire storage space and in a second direction when the winch drum releases the spare tire from the tire storage space. The pawl is configured to move between a locked configuration that prevents the ratchet gear from rotating in the second direction and an unlocked configuration that allows the ratchet gear to rotate in the second direction. The release mechanism is located at a remote location from the pawl and is configured to cause the pawl to move into the unlocked configuration thereby allowing the ratchet gear to rotate in the second direction and the winch drum to release the spare tire from the tire storage space.

Another aspect of the present disclosure is to provide a vehicle including a tire storage space, a tire hoist and a spare tire anti-theft device. The tire storage space is accessible from an underside of the vehicle. The tire hoist is configured to wind a spare tire into the tire storage space and release the spare tire from the tire storage space. The spare tire anti-theft device includes a locking mechanism, a lever and a mechanical line. The locking mechanism is configured to alternate between a locked configuration that prevents the tire hoist from releasing the spare tire from the tire storage space and an unlocked configuration that allows the tire hoist to release the spare tire from the tire storage space. The lever is accessible without accessing the underside of the vehicle. The mechanical line connects the lever to the locking mechanism such that moving the lever causes the mechanical line to move the locking mechanism into the unlocked configuration.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 illustrates a side elevational view of an example embodiment of a vehicle including a spare tire anti-theft storage system in accordance with the present disclosure;

FIG. 2 illustrates a top perspective view of the rear end of the vehicle of FIG. 1;

FIG. 3 illustrates a top plan view of the rear end of the vehicle of FIG. 1;

FIG. 4 illustrates a top perspective view of an example embodiment of a spare tire anti-theft storage system in accordance with the present disclosure;

FIG. 5 illustrates an exploded view of the spare tire anti-theft storage system of FIG. 4;

FIG. 6 illustrates a top perspective view of certain parts of the spare tire anti-theft storage system of FIG. 4;

FIG. 7 illustrates a side elevational view of certain parts of the spare tire anti-theft storage system of FIG. 4;

FIG. 8 illustrates another side elevational view of certain parts of the spare tire anti-theft storage system of FIG. 4;

FIG. 9 illustrates a top perspective view of certain parts of the spare tire anti-theft storage system of FIG. 4 located at a secured environment in accordance with the present disclosure; and

FIG. 10 illustrates another top perspective view of certain parts of the spare tire anti-theft storage system of FIG. 4 located at a secured environment in accordance with the present disclosure.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

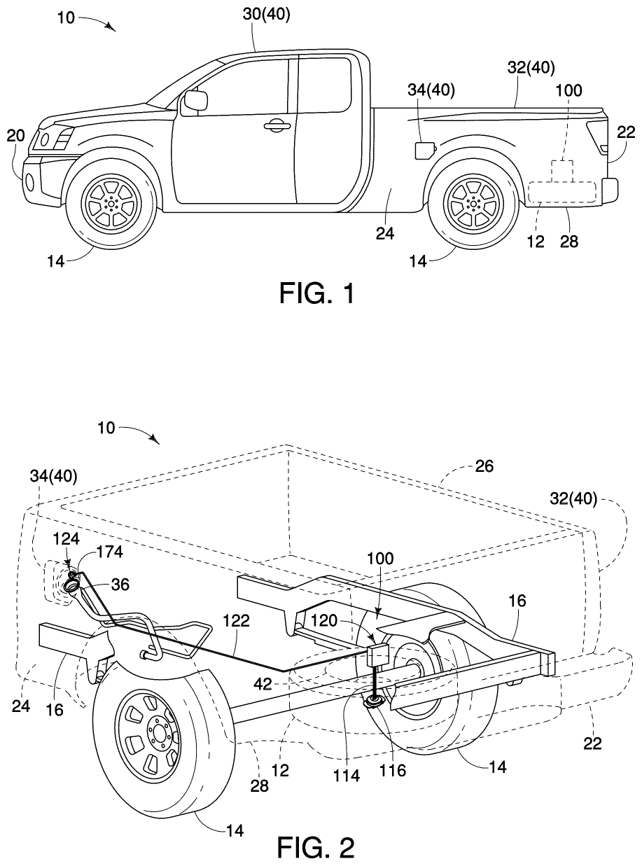

FIGS. 1 to 3 illustrate an example embodiment of a vehicle 10 including a spare tire anti-theft storage system 100 in accordance with the present disclosure. The spare tire anti-theft storage system 100 is configured to store a spare tire 12 so that it can be accessed by the owner of the vehicle 10 as needed to replace one of the other tires 14 of the vehicle 10, while also preventing access to the spare tire 12 by anyone not authorized to access the vehicle 10.

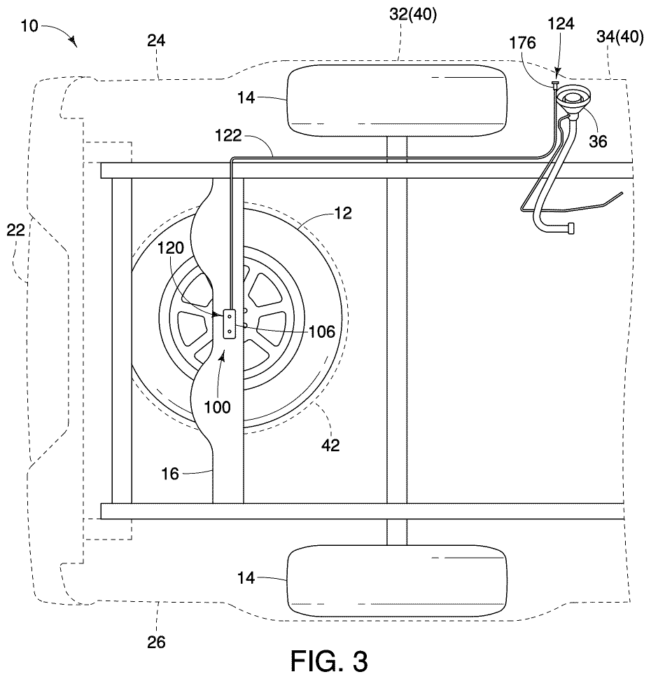

In the illustrated embodiment, the vehicle 10 is a truck, specifically a pickup truck having a flatbed, but those of ordinary skill in the art will recognize from this disclosure that the spare tire anti-theft storage system 100 can be included on other types of trucks or other vehicles such as SUVs, vans and cars. In the illustrated embodiment, the spare tire anti-theft storage system 100 is attached to the frame 16 of the vehicle 10 on the underside of the flatbed, as seen for example in FIGS. 2 and 3.

As seen in FIGS. 1 to 3, the vehicle 10 includes a front side 20, a rear side 22, a first (driver's) side 24, a second (passenger) side 26 and an underside 28. In the illustrated embodiment, the vehicle 10 includes a passenger cabin 30 at the front side 20, a flatbed 32 at the rear side 22, and a fueling compartment 34 on the driver's side 24. The fueling compartment 34 can also be located at another location such as the passenger side 26 or rear side 22 in other vehicles. The fueling compartment 34 typically includes a fuel tank inlet 36 that the vehicle operator uses to pump fuel into the vehicle 10.

The vehicle 10 includes one or more secured environment 40. The secured environments 40 are typically enclosed and/or locked and can only be opened by the vehicle operator or another authorized person with the key to the vehicle 10. In the illustrated embodiment, the passenger cabin 30 is one secured environment 40 that requires a key for entry. The flatbed 32 or trunk is another secured environment 40 that can require a key for entry. The fueling compartment 34 is yet another secured environment 40 that can require a key for entry. In an embodiment, the flatbed 32 or trunk, the fueling compartment 34 and/or another secured environment 40 can be unlocked through a button or switch in another part of the vehicle 10, such as a button or switch in the passenger cabin 30, where the vehicle occupant uses a key to open the passenger cabin 30 and then unlocks the flatbed 32 or trunk, the fueling compartment 34 or the other secured environment 40 using the button or switch in the passenger cabin 30.

As seen in FIGS. 2 and 3, the vehicle 10 includes a tire storage space 42. In the illustrated embodiment, the tire storage space 42 is located on and accessible from the underside 28 of the vehicle 10. More specifically, the tire storage space 42 is located on the underside 28 of the flatbed 32 at the rear side 22 of the vehicle 10.

In the illustrated embodiment, the spare tire anti-theft storage system 100 includes a tire hoist 102 and a spare tire anti-theft device 104. The spare tire anti-theft system 100 can combine the tire hoist 102 and the spare tire anti-theft device 104 into a single system as illustrated. Alternatively, the spare tire anti-theft storage system 100 can be considered to be two systems, with the tire hoist 102 being a first or lowering system (e.g., turning a crank with a rod or by an electric mechanism), and with the spare tire anti-theft device 104 being a second or unlocking system (e.g., including a locking pawl that locks the first system as discussed herein). Both the first and second systems can be mechanically or electrically operated, or a combination thereof.

The spare tire anti-theft device 104 moves between an unlocked configuration and a locked configuration to lock and unlock the tire hoist 102. The spare tire anti-theft storage system 100 allows the tire hoist 102 to lower the spare tire 12 from the tire storage space 42 when the spare tire anti-theft device 104 is in the unlocked configuration, and prevents the tire hoist 102 from lowering the spare tire 12 from the tire storage space 42 when the spare tire anti-theft device 104 is in the locked configuration. In the illustrated embodiment, the spare tire anti-theft storage system 100 allows the tire hoist 102 to raise the spare tire 12 into the tire storage space 42 when the spare tire anti-theft device 104 is in either the unlocked configuration or the locked configuration. This allows the vehicle operator to always raise the spare tire 12 into the tire storage space 42 regardless of the configuration of the spare tire anti-theft device 104, but only to lower the spare tire 12 from the tire storage space 42 after the spare tire anti-theft device 104 has been unlocked.

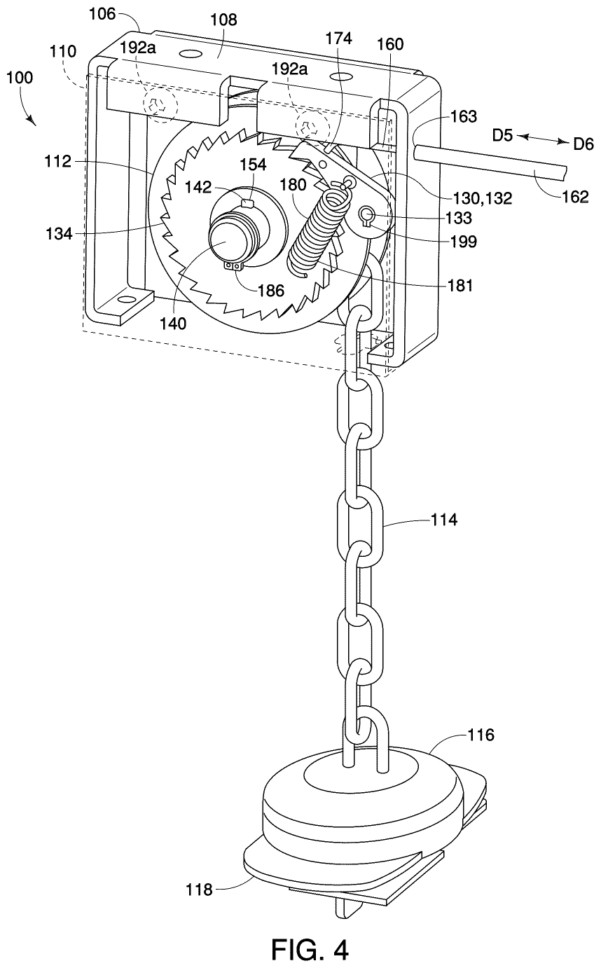

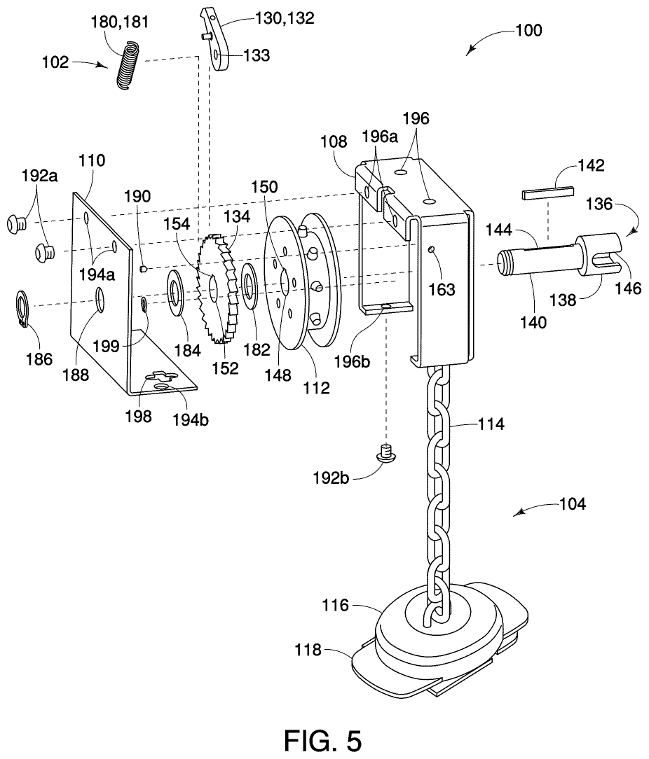

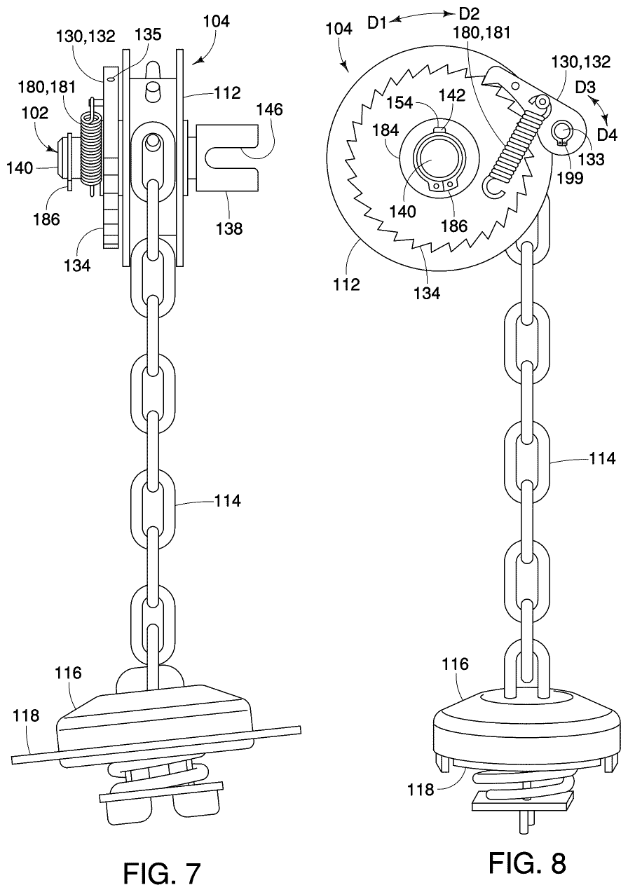

FIGS. 4 to 10 illustrate the spare tire anti-theft storage system 100 in more detail. In the illustrated embodiment, the system 100 includes a housing 106 that houses at least some of the components for each of the tire hoist 102 and the spare tire anti-theft device 104. As seen in FIG. 5, the housing 106 includes a first housing part 108 and a second housing part 110. The housing 106 enables mounting of the system 100 components stored therein to the vehicle frame 16 above the tire storage space 42 on the underside 28 of the vehicle 10, and also prevents a tire thief from tampering with the components stored therein to unlock the spare tire anti-theft device 104. The spare tire anti-theft storage system 100 can also be constructed with a different type of housing or mount or be located at a different position.

The tire hoist 102 is configured to wind a spare tire 12 into the tire storage space 42 and release the spare tire 12 from the tire storage space 42. In the illustrated embodiment, the tire hoist 102 includes a winch drum 112, a mechanical line 114 (here, a chain), and a coupling mechanism 116. The coupling mechanism 116 is removeably attachable to the spare tire 12, for example, by having a part that attaches to and/or supports the spare tire 12 at the center thereof. In the illustrated embodiment, the coupling mechanism 116 includes a movable or detachable platform 118 that is wider than the inner axial space of the spare tire 12 and supports and lifts the spare tire 12 from an underside thereof when the spare tire 12 is positioned on its side.

The winch drum 112 is configured to wind the mechanical line 114 to pull the spare tire 12 into the tire storage space 42 via the coupling mechanism 116, and to unwind the mechanical line 114 to release the spare tire 12 from the tire storage space 42. The winch drum 112 rotates in a first direction D1 (e.g., counterclockwise as shown in FIG. 8) to wind the mechanical line 114 to raise the spare tire 12 into the tire storage space 42 via the coupling mechanism 116, and rotates in a second direction D2 (e.g., clockwise as shown in FIG. 8) to unwind the mechanical line 114 to lower the spare tire 12 from the tire storage space 42. As seen in FIGS. 4 and 5, the winch drum 112 is located within the housing 106, and the mechanical line 114 passes through an aperture 198 in the housing 106.

When the spare tire anti-theft device 104 unlocks the tire host 102, the tire host 102 can release the spare tire 12 from the tire storage space 42 by unwinding the mechanical line 114 using the winch drum 112. When the spare tire anti-theft device 104 locks the tire host 102, the winch drum 112 is prevented from rotating to releasing the spare tire 12 from the tire storage space 42. In the illustrated embodiment, the spare tire anti-theft device 104 allows the winch drum 112 to pull the spare tire 12 into the tire storage space 42 when in both the locked configuration and the unlocked configuration. In an alternative embodiment, the spare tire anti-theft device 104 can be modified to have a locked configuration that prevents the winch drum 112 from raising or lowering the spare tire 12.

As seen in FIGS. 2 and 3, the spare tire anti-theft device 104 includes a locking mechanism 120, a mechanical line 122 and a release mechanism 124. The locking mechanism 120 mechanically interacts with one or more components of the tire hoist 102 to lock and unlock the tire hoist 102. The locking mechanism 120 is configured to alternate between the locked configuration that prevents the tire hoist 102 from releasing the spare tire 12 from the tire storage space 42 and the unlocked configuration that allows the tire hoist 102 to release the spare tire 12 from the tire storage space 42. The mechanical line 122 connects the locking mechanism 120 to the release mechanism 124, such that the release mechanism 124 causes the mechanical line 122 to move the locking mechanism 120 from the locked configuration into the unlocked configuration. In the illustrated embodiment, the locking mechanism 120 is always biased into the locked configuration unless the release mechanism 124 causes movement of the locking mechanism 120 to the unlocked configuration, for example, via movement of the mechanical line 122.

The locking mechanism 120 includes a latch 130 configured to move between a first position and a second position. The first position corresponds to the locked configuration (e.g., as shown in FIG. 8) and the second position corresponds to the unlocked configuration. When the latch 130 moves from the unlocked configuration to the locked configuration, the latch 130 moves in the direction D3 in FIG. 8, and when the latch 130 moves from the locked configuration to the unlocked configuration, the latch moves in the direction D4 in FIG. 8. Thus, the latch 130 is configured to move between the locked configuration (first position) that prevents the tire hoist 102 from releasing the spare tire 12 from the tire storage space 42 and the unlocked configuration (second position) that allows the tire hoist 102 to release the spare tire 12 from the tire storage space 42.

In the illustrated embodiment, the latch 130 includes a pawl 132, and the locking mechanism 120 includes the pawl 132 and a ratchet gear 134. In the illustrated embodiment, the pawl 132 includes an aperture 133 by which the pawl 132 is pivotally attached to the housing 106, and the pawl 132 rotates around the center axis of the aperture 133 to move into and out of engagement with the ratchet gear 134. The pawl 132 is biased into and engages the ratchet gear 130 when the locking mechanism 120 is in the locked configuration (e.g., the pawl 132 is biased in the direction D3 in FIG. 8), and the pawl 132 is moved away from and disengages the ratchet gear 134 when the locking mechanism is in the unlocked configuration (e.g., the pawl 132 is moved in the direction D4 in FIG. 8). In the illustrated embodiment, the latch 130/pawl 132 allows the ratchet gear 134 to rotate in the first direction D1 (see FIG. 8) when a lever 172 of the release mechanism 124 is in both its first position and its second position as discussed in more detail below.

In the illustrated embodiment, the ratchet gear 134 and the winch drum 112 are separate parts that rotate in unison around a common center axis. The ratchet gear 134 is operatively coupled to the winch drum 112 such that the ratchet gear 134 and the winch drum 112 rotate together. More specifically, the spare tire anti-theft storage system 100 includes an axle 136 that operatively couples the winch drum 112 and the ratchet gear 134. As seen in FIG. 5, the axle 136 passes through the center axis of each of the winch drum 112 and the ratchet gear 134. In the illustrated embodiment, the axle 136 includes an attachment end 138, a cylindrical part 140, and a protruding part 142. The attachment end 138 includes an indentation 146, such that a driving mechanism can attach at the indentation 146 and drive rotation of the axle 136 to wind and unwind the spare tire 12 into and out of the tire storage space 42. In the illustrated embodiment, the cylindrical part 140 further includes an indentation 144 sized and shaped to receive the protruding part 142. In an alternative embodiment, the protruding part 142 can be integrally formed as part of the cylindrical part 140.

The winch drum 112 includes a center aperture 148, and the ratchet gear 134 includes a center aperture 152. The winch drum 112 receives the axle 136 at the central axis of the center aperture 148, and includes a radial indentation 150 sized and shaped to receive the protruding part 142. Similarly, the ratchet gear 134 receives the axle 136 at the central axis of the center aperture 152, and includes a radial indentation 154 sized and shaped to receive the protruding part 142. In the illustrated embodiment, the same protruding part 142 extends from the axle 136 into both the radial indentation 150 of the winch drum 112 and the radial indentation 154 of the ratchet gear 134. In an alternative embodiment, the protruding part 142 can include a first protruding part that extends into the radial indentation 150 of the winch drum 112 and a second protruding part that extends into the radial indentation 154 of the ratchet gear 134. In another alternative embodiment, the winch drum 112 and the ratchet gear 134 can be formed together as a single piece that rotates in the first direction D1 and the second direction D2.

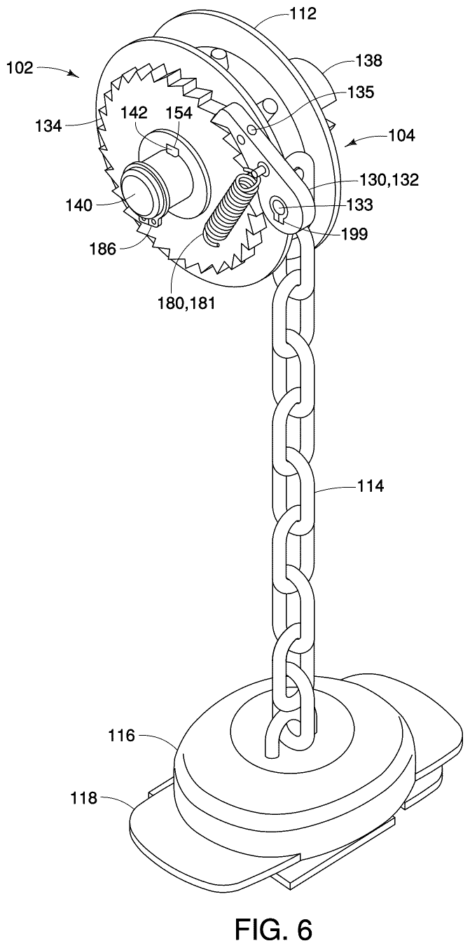

With the winch drum 112 and the ratchet gear 134 operatively coupled as shown in FIGS. 6 to 8, the winch drum 112 and the ratchet gear 134 rotate in unison in both the first direction D1 and the second direction D2. The ratchet gear 134 thus rotates in the first direction D1 when the tire hoist 102 winds the spare tire 12 into the tire storage space 42 and in the second direction D2 when the tire hoist 102 releases the spare tire 12 from the tire storage space 42. More specifically, the ratchet gear 134 rotates in unison with the winch drum 112 in the first direction D1 when the winch drum 112 winds the spare tire 12 into the tire storage space 42 and in the second direction D2 when the winch drum 112 releases the spare tire 12 from the tire storage space 42.

The pawl 132 is configured to move between the locked configuration that prevents the ratchet gear 134 from rotating in the second direction D2 and the unlocked configuration that allows the ratchet gear 134 to rotate in the second direction D2. The pawl 132 allows the ratchet gear 130 to rotate in the first direction D1 (e.g., counterclockwise in FIG. 8) whether in the locked configuration or the unlocked configuration. The pawl 132 allows the ratchet gear 130 to rotate in the second direction D2 (e.g., clockwise in FIG. 8) only when in the unlocked configuration. Since the ratchet gear 134 is operatively coupled to the winch drum 112, the pawl 132 also allows the winch drum 112 to rotate in the first direction D1 whether in the locked configuration or the unlocked configuration, and allows the winch drum 112 to rotate in the second direction D2 only when in the unlocked configuration.

In the illustrated embodiment, the mechanical line 122 includes a metal wire 160 (e.g., a steel wire). More specifically, the mechanical line 122 includes a metal wire 160 and a sheath 162. The metal wire 160 translates within and with respect to the sheath 162, which prevents the metal wire 160 from rubbing against other parts of the vehicle 12 as it moves to lock and unlock the tire hoist 102. In the illustrated embodiment, the pawl 132 includes an attachment point 135 (see FIG. 8) at an opposite end thereof than the aperture 133, and the mechanical line 122 is attached to the pawl 132 at the attachment point 135. The mechanical line 122 is thus configured to pull the pawl 132 at the attachment point 135 to cause the pawl 132 to disengage from the ratchet gear 134.

In an embodiment, the sheath 162 can be made of plastic, metal or another durable material. One advantage to a metal sheath 162 is that a tire thief cannot easily cut or pull on the sheath 162 to cause the metal wire 160 to pull the pawl 132 out of engagement with the ratchet gear 134 to place the spare tire anti-theft device 104 in the unlocked configuration. As seen for example in FIGS. 4 and 5, the sheath 162 can attach to and/or extend into an aperture 163 in the housing 106, so that a thief cannot insert a tool to access and pull the metal wire 160 away from the housing 106 to pull the pawl 132 out of engagement with the ratchet gear 134. The sheath 162 can also attach to the outside of and/or extend into the secured environment 40 so that a thief cannot insert a tool to access and pull the metal wire 160 to pull the pawl 132 out of engagement with the ratchet gear 134.

The release mechanism 124 enables movement of the mechanical line 122 in a locking direction D5 and causes movement of the mechanical line 122 in an unlocking direction D6 (e.g., as shown in FIG. 4). More specifically, the release mechanism 124 causes the metal wire 160 to translate within the sheath 162 in the unlocking direction D6 to unlock the locking mechanism 120, and the release mechanism 124 also allows the metal wire 160 to translate within the sheath 162 in the locking direction D5. When the metal wire 160 translates in the unlocking direction D6, the pawl 132 disengages the ratchet gear 134.

The release mechanism 124 is located in a secured environment 40 of the vehicle 10. In the illustrated embodiment, the release mechanism 124 is located in the fueling compartment 34 of the vehicle 10. Newer vehicles generally have an automatic lock on the fueling compartment 34 that must be unlocked from the passenger cabin 30, so a person can only actuate the release mechanism 124 to unlock the tire hoist 102 if they have access to unlock the passenger cabin 30. In other embodiments, the release mechanism 124 can be located in another secured environment 40 such as the passenger cabin 30, the flatbed 32 or trunk, or another secured environment 40 on the vehicle 10.

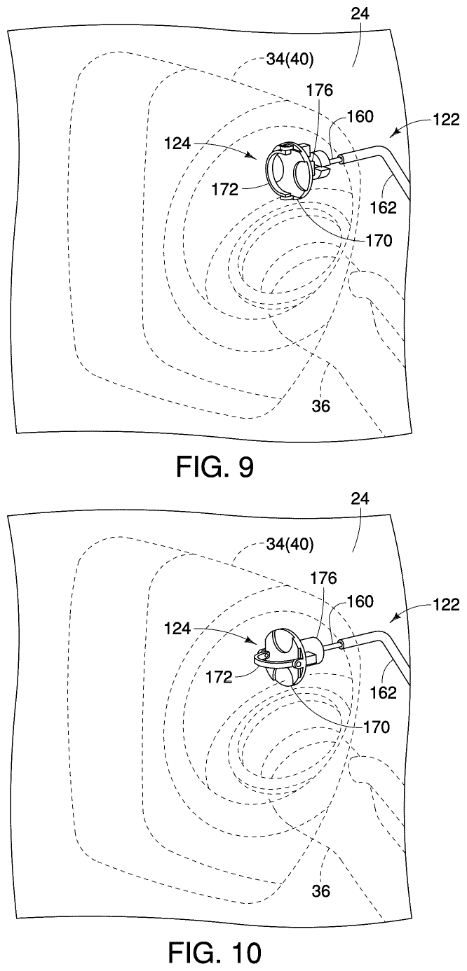

As seen in FIGS. 9 and 10, the release mechanism 124 includes a mount 170 and a lever 172. The mount 170 is mounted within the secured environment 40, for example, within the fueling compartment 34 in the illustrated embodiment. The lever 172 is operable between a first position and a second position and moves with respect to the mount 170. A vehicle operator or other authorized person can actuate the lever 172 by unlocking/opening the secured environment 40 and physically moving the lever 172 between the first position and the second position. FIG. 9 shows the lever 172 is in the first position, such that the locking mechanism 120 is in the locked configuration. FIG. 10 shows the lever 172 in the second position, such that the locking mechanism 120 is in the unlocked configuration. In the illustrated embodiment, a vehicle operator or other authorized person actuates the lever 172 by pulling it away from the mount 170 and rotating it, as seen for example by the changed position shown in FIGS. 9 and 10. Those of ordinary skill in the art will recognize from this disclosure that the lever 170 can be actuated in other ways. In an alternative embodiment, the lever 172 can be electronically actuated, for example, by a vehicle operator or passenger pressing a button inside the passenger cabin 30.

In the illustrated embodiment, the lever 172 is accessible without accessing the underside 28 of the vehicle 10. The lever 172 is thus accessible without crawling underneath the underside 28 of the vehicle. More specifically, the lever 172 is only accessible from the secured environment 40 that is not on the underside 28 of the vehicle 10. For example, as seen in FIGS. 2, 3, 9 and 10, the release mechanism 124 including the lever 172 is accessible from the fueling compartment 34, which is accessible from the first side 24 of the vehicle 10. Alternatively, the lever 172 can be accessible from another secured environment 40 without accessing the underside 28 of the vehicle 10.

The mechanical line 122 has a first end 174 and a second end 176. The first end 174 of the mechanical line 122 is operatively connected to the locking mechanism 120 (e.g., as seen in FIG. 4). Specifically, the first end 174 of the mechanical line 122 is operatively connected to the latch 130. More specifically, the first end 174 of the mechanical line 122 is operatively connected to the pawl 132 at the attachment point 135. The second end 176 of the mechanical line 122 is operatively connected to the release mechanism 124 (e.g., as seen in FIGS. 9 and 10). Specifically, the second end 176 of the mechanical line 122 is operatively connected to the lever 172. Thus, the mechanical line 122 operatively connects the latch 130/pawl 132 to the lever 172.

The mechanical line 122 connects the lever 172 to the locking mechanism 120 such that moving the lever 172 causes the mechanical line 122 to move in the direction D6 (see FIG. 4), which causes the locking mechanism 120 to move into the unlocked configuration. More specifically, the first end 174 of the mechanical line 122 is operatively connected to the latch 130, and the second end 176 of the mechanical line 122 is operatively connected to the lever 172. The mechanical line 122 causes the latch 130 to move from the locked configuration to the unlocked configuration when the lever 172 is moved from the first position (e.g., as seen in FIG. 9) to the second position (e.g., as seen in FIG. 10) so that the tire hoist 102 can release the spare tire 12 from the tire storage space 42. Moving the lever 172 thus causes the mechanical line 122 to pull the latch 130 against a biasing force and into the unlocked configuration.

In the illustrated embodiment, the locking mechanism 120 includes a biasing mechanism 180. The biasing mechanism 180 applies a biasing force that biases the pawl 132 into the locked configuration unless the release mechanism 124 causes the pawl 132 to move into the unlocked configuration against the biasing force. Here, the biasing mechanism 180 includes a spring 181. More specifically, the biasing mechanism 180 includes a spring 181 that biases the pawl 132 into the ratchet gear 134 to prevent rotation of the ratchet gear 132 in the second direction D2 unless the lever 172 is moved from the first position (e.g., as seen in FIG. 9) to the second position (e.g., as seen in FIG. 10). Those of ordinary skill in the art will recognize from this disclosure that other types of biasing mechanisms 180 can also be used. For example, the biasing mechanism 180 can include a plastic or other piece that flexes when the pawl 132 is pulled away from the ratchet gear 134.

The biasing mechanism 180 biases the latch 130 into the locked configuration. More specifically, the biasing mechanism 180 biases the pawl 132 into engagement with the ratchet gear 134 in the locked configuration (e.g., biases the ratchet gear 134 in the direction D3 in FIG. 8). When the locking mechanism 120 is in the unlocked configuration, the pawl 132 is moved away from the ratchet gear 134 (e.g., in the direction D4 in FIG. 8) by the mechanical line 122 against the force of the biasing mechanism 180.

FIG. 5 further illustrates an example embodiment of how the components of the spare tire anti-theft storage system 100 can be attached to each other. Here, the spare tire anti-theft storage system 100 further includes a first washer 182, a second washer 184 and a clip 186. The cylindrical portion 140 of the axle 136 extends through the center aperture 148 of the winch drum 112, through the first washer 182, through the center aperture 152 of the ratchet gear 134, through the second washer 184, through an aperture 188 in the second housing part 110, and into the clip 186 which holds the parts together. The first washer 182 is thus located between the winch drum 112 and the ratchet gear 134, and the second washer 184 is located between the ratchet gear 134 and the second housing part 110. As seen in FIG. 4, the clip 188 is located outside of the housing 106 when installed on the axle 136.

As further seen in FIG. 5, the first housing part 108 and the second housing part 110 can be attached by screws or bolts 192a that pass though apertures 194a in the second housing part 110 and corresponding apertures 196a in the first housing part 106. The first housing part 108 and the second housing part 110 can also be attached by screws or bolts 192b that pass though apertures 194b in the second housing part 110 and corresponding apertures 196b in the first housing part 108. The housing 106 can then be attached to the frame 16 of the vehicle, for example, by screws or bolts through apertures 196 in the housing 106. The latch 130/pawl 132 can also include an attaching part 190 attached thereto or integrated therewith that connects the latch 130/pawl 132 to the first end 174 of the mechanical line 122. The latch 130/pawl 132 can also include a clip 199 that pivotally attaches the latch 130/pawl 132 to the housing 106.

The spare tire anti-theft storage system 100 disclosed herein is tamperproof in several ways. For example, the components located within the housing 106 are protected by the housing 106 so that they cannot be accessed from the underside 28 of the vehicle 10. Additionally, cutting the mechanical line 122 causes the spare tire anti-theft device 104 to remain into the locked configuration, since the biasing mechanism 180 always biases the latch 130/pawl 132 into the locked configuration unless pulled into the unlocked configuration via the mechanical line 122. Thus, tampering with the anti-theft storage system 100 by cutting the mechanical line 122 will cause the locking mechanism 20 to remain locked so that the spare tire 12 cannot be released. Further, the sheath 162 prevents a thief from accessing and pulling the metal wire 160 with a tool to place the spare tire anti-theft device 104 in the unlocked configuration. The release mechanism 124 can also only be accessed by an authorized person having a key to the vehicle 12 since the release mechanism 124 is located in a secured environment 40 (e.g., fueling compartment 34) which can only be accessed by someone with a key to the passenger cabin 30.

The embodiments described herein provide improved systems, methods and devices for locking and unlocking a tire hoist. These systems and methods are advantageous, for example, because they have tamperproof features and enable a vehicle operator to unlock the tire hoist from a secured environment without accessing the underside of the vehicle. It should be understood that various changes and modifications to the systems and methods described herein will be apparent to those skilled in the art and can be made without diminishing the intended advantages.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A spare tire anti-theft device for a vehicle, the device comprising:
a latch configured to move between a locked configuration that prevents a tire hoist from releasing a spare tire from a tire storage space and an unlocked configuration that allows the tire hoist to release the spare tire from the tire storage space;
a lever operable between a first position and a second position; and
a mechanical line including a first end operatively connected to the latch and a second end operatively connected to the lever,
the mechanical line causing the latch to move from the locked configuration to the unlocked configuration when the lever is moved from the first position to the second position so that the tire hoist can release the spare tire from the tire storage space.

2. The device of claim 1, comprising
a ratchet gear configured to operatively connect to a winch drum so as to rotate in a first direction when the winch drum winds the spare tire into the tire storage space and in a second direction when the winch drum releases the spare tire from the tire storage space, and
the latch includes a pawl that is biased into the ratchet gear in the locked configuration and moved away from the ratchet gear by the mechanical line in the unlocked configuration.

3. The device of claim 2, comprising
a spring that biases the pawl into the ratchet gear to prevent rotation of the ratchet gear in the second direction unless the lever is moved from the first position to the second position.

4. The device of claim 2, wherein
the ratchet gear is configured to rotate in unison with the winch drum in the first direction when the winch drum winds the spare tire into the tire storage space and in the second direction when the winch drum releases the spare tire from the tire storage space.

5. The device of claim 2, wherein
the pawl allows the ratchet gear to rotate in the first direction when the lever is in both the first position and the second position.

6. The device of claim 1, wherein
the mechanical line includes a metal wire connecting the latch to the lever.

7. A spare tire anti-theft storage system for a vehicle, the system comprising:
a winch drum configured to wind a spare tire into a tire storage space and release the spare tire from the tire storage space;
a ratchet gear operatively connected to the winch drum and configured to rotate in a first direction when the winch drum winds the spare tire into the tire storage space and in a second direction when the winch drum releases the spare tire from the tire storage space;
a pawl configured to move between a locked configuration that prevents the ratchet gear from rotating in the second direction and an unlocked configuration that allows the ratchet gear to rotate in the second direction; and
a release mechanism located at a remote location from the pawl, the release mechanism configured to cause the pawl to move into the unlocked configuration thereby allowing the ratchet gear to rotate in the second direction and the winch drum to release the spare tire from the tire storage space.

8. The system of claim 7, comprising
a biasing mechanism applying a biasing force that biases the pawl into the locked configuration unless the release mechanism causes the pawl to move into the unlocked configuration against the biasing force.

9. The system of claim 7, comprising
a mechanical line having a first end and a second end,
wherein the release mechanism includes a lever, the first end of the mechanical line is operatively connected to the pawl, and the second end of the mechanical line is operatively connected to the lever such that moving the lever causes the pawl to move into the unlocked configuration.

10. The system of claim 7, wherein
the pawl allows the ratchet gear to rotate in the first direction when in the locked configuration.

11. The system of claim 7, wherein
the ratchet gear and the winch drum are separate parts that rotate in unison around a common center axis.

12. The system of claim 7, wherein
the tire storage space is located on an underside of the vehicle, and
the release mechanism is accessible without accessing the underside of the vehicle.

13. The system of claim 12, wherein
the release mechanism includes a lever that is accessible from a fueling compartment of the vehicle.

14. A vehicle comprising:
a tire storage space accessible from an underside of the vehicle;
a tire hoist configured to wind a spare tire into the tire storage space and release the spare tire from the tire storage space; and
a spare tire anti-theft device including
a locking mechanism configured to alternate between a locked configuration that prevents the tire hoist from releasing the spare tire from the tire storage space and an unlocked configuration that allows the tire hoist to release the spare tire from the tire storage space,
a lever accessible without accessing the underside of the vehicle, and
a mechanical line connecting the lever to the locking mechanism such that moving the lever causes the mechanical line to move the locking mechanism into the unlocked configuration.

15. The vehicle of claim 14, wherein
the vehicle includes a fueling compartment including a gas tank inlet, and
the lever is accessible from the fueling compartment.

16. The vehicle of claim 14, wherein
the vehicle is a pickup truck having a flatbed, and
the tire storage space is located on the underside of the flatbed.

17. The vehicle of claim 14, wherein
the mechanical line includes a metal wire.

18. The vehicle of claim 14, wherein
the locking mechanism includes a ratchet gear and a pawl, the pawl biased into the ratchet gear when the locking mechanism is in the locked configuration and moved away from the ratchet gear when the locking mechanism is in the unlocked configuration.

19. The vehicle of claim 18, wherein
the ratchet gear rotates in a first direction when the tire hoist winds the spare tire into the tire storage space and in a second direction when the tire hoist releases the spare tire from the tire storage space, and
the pawl allows the ratchet gear to rotate in the first direction when the locking mechanism is in the locked configuration.

20. The vehicle of claim 14, wherein
the tire hoist includes a winch drum, a chain and a coupling mechanism removeably attachable to the spare tire, the winch drum configured to wind the chain to pull the tire into the tire storage space via the coupling mechanism.
